(19) United States
(12) Patent Application Publication
(10) Pub. No.: US 2025/0137970 A1
(43) Pub. Date: May 1, 2025

(54) ULTRASONIC INSPECTION METHOD

(71) Applicant: HITACHI-GE NUCLEAR ENERGY, LTD., Ibaraki (JP)

(72) Inventors: Takaaki Konishi, Tokyo (JP); Masahiro Miki, Tokyo (JP); Akihiko Hirano, Ibaraki (JP); Junta Yamada, Ibaraki (JP)

(73) Assignee: HITACHI-GE NUCLEAR ENERGY, LTD., Ibaraki (JP)

(21) Appl. No.: 18/923,909

(22) Filed: Oct. 23, 2024

(30) Foreign Application Priority Data
Oct. 27, 2023 (JP) 2023-184946

(51) Int. Cl. G01N 29/04; G01B 17/02

(52) U.S. Cl. CPC G01N 29/043; G01B 17/02; G01N 2291/02854

(57) ABSTRACT

To provide an ultrasonic inspection method for performing a wall thickness measurement of a pipe or the like provided with a protective material such as an exterior plate implemented by a metal member, from the outside without removing the exterior plate or the like. The ultrasonic inspection method is implemented by an ultrasonic sensor provided on a surface of an object, a sensor coil connected to the ultrasonic sensor, and a transmission and reception coil provided on an outside of an exterior plate. The exterior plate is provided with an opening having a full width in one direction larger than a diameter of the coil.

### CLAIM OF PRIORITY

The present application claims priority from Japanese Patent application serial no. 2023-184946 filed on Oct. 27, 2023, the content of which is hereby incorporated by reference into this application.

### TECHNICAL FIELD

The present invention relates to an ultrasonic inspection method for measuring a thickness reduction or a defect occurring in a pipe of, for example, a nuclear power plant and a thermal power plant using ultrasonic waves.

### BACKGROUND ART

The maintenance of components in a power plant is required to maintain normal operation, and the role of a non-destructive inspection technology is highly important. In particular, in a nuclear power plant, it is important to ensure soundness of a primary device of a nuclear reactor, such as a recirculation system pipe. It is known that a bent portion of a pipe through which water vapor or the like having a high temperature and a high flow velocity flows may be reduced in thickness due to erosion and corrosion such as impact corrosion, which causes a problem in device maintenance. Therefore, an inspection is performed in which ultrasonic pulses are incident from an outside of a pipe, reflected waves from an inner wall surface of the pipe are received, and a pipe wall thickness is measured based on a time difference between a plurality of reflected pulses.

In a method according to the related art, a vertical probe is used, and the probe is brought into direct contact with an outer surface of a pipe to perform inspection of the wall thickness of a pipe immediately below the probe. On the other hand, in a pipe through which a high-temperature fluid flows during plant operation, a heat-preservation material is wound around the outside of the pipe, and an exterior plate holding the heat-preservation material is provided on the outside of the heat-preservation material.

Therefore, during the wall thickness inspection, it is required to remove the heat-preservation material and the exterior plate first, and to recover after the inspection is performed. The probe is brought into direct contact with an inspection location in the inspection, and therefore, it is required to assemble a scaffold when the inspection location is high.

In order to solve such a problem, for example, as described in PTL 1, a method of performing an inspection from a position away from a surface of an inspection target by providing a sensor, a reception coil, and a transmission coil in advance on a surface of the inspection target, and transmitting and receiving signals by electromagnetic induction coupling between the reception coil and the transmission coil has been reported.

### CITATION LIST

### Patent Literature

PTL 1: GB2523266A

### SUMMARY OF INVENTION

### Technical Problem

However, in the method disclosed in PTL 1, electromagnetic induction coupling occurs when only the heat-preservation material implemented by a non-metal member is wound around the pipe. However, when the exterior plate implemented by a metal member is provided on the outside of the heat-preservation material, the transmission and reception of a signal cannot be performed by electromagnetic induction coupling from the outside.

Therefore, the invention has been made in view of the above problems, and an object of the invention is to provide an ultrasonic inspection method for performing a wall thickness measurement of a pipe or the like provided with a protective material such as an exterior plate implemented by a metal member, by which the wall thickness measurement of the pipe or the like can be performed from the outside of the exterior plate without requiring removal of the exterior plate.

### Solution to Problem

In order to achieve the above object, an ultrasonic inspection method according to the invention is implemented by an ultrasonic sensor attached to a surface of an object, a sensor coil electrically connected to the ultrasonic sensor, and a transmission and reception coil provided facing the sensor coil via a metal member provided on an outside of the object, and the metal member provided on the outside of the object is provided with an opening.

### Advantageous Effects of Invention

According to the invention, it is possible to measure a wall thickness of a pipe from an outside of a metallic exterior plate without impairing the retention of a heat-preservation material of the exterior plate and without requiring removal of the exterior plate.

### BRIEF DESCRIPTION OF DRAWINGS

FIG. 1 is a diagram showing a configuration of an inspection device according to a first embodiment of the invention.

FIG. 2 is a side cross-sectional view showing a structure of a coil and a sensor according to the first embodiment of the invention.

FIG. 3 is a diagram illustrating an example in which a magnetic flux for inducing electromagnetic induction is weakened, for comparison with the first embodiment of the invention.

FIG. 4 is a diagram illustrating an example of a method for generating the magnetic flux for inducing electromagnetic induction in the first embodiment of the invention.

FIG. 5 is a diagram showing a part of a configuration of an inspection device according to a second embodiment of the present invention.

### DESCRIPTION OF EMBODIMENTS

Hereinafter, a first embodiment will be described with reference to the drawings.

### Embodiment 1

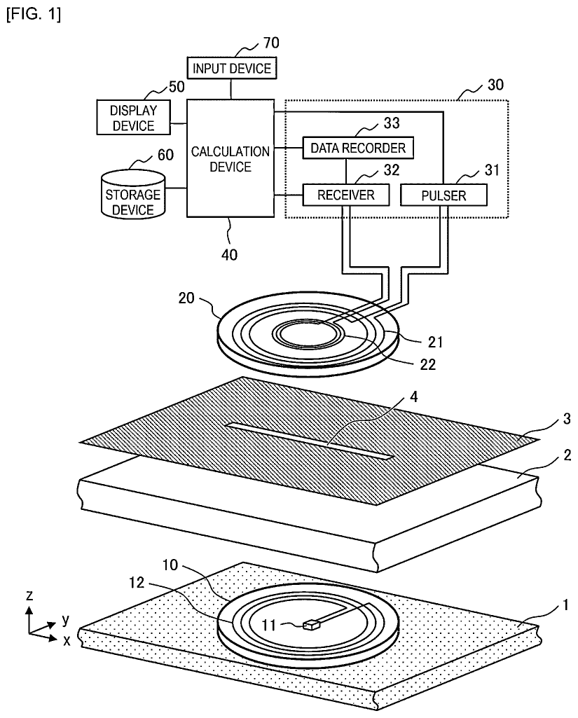

An outline of the present inspection method will be described with reference to FIGS. 1 to 4.

FIG. 1 is a diagram showing a configuration of an inspection device according to the present embodiment.

An object 1 is, for example, a recirculation system pipe of a nuclear power plant or the like, and a part thereof is shown.

A heat-preservation material 2 implemented by a non-metal member is wound around an outer periphery of the pipe. An exterior plate 3 implemented by a metal member is provided to support the heat-preservation material 2, and ultrasonic inspection is performed to measure a wall thickness of the pipe.

The inspection device includes a sensor 10 provided on a surface of the object 1, a sensor probe 20 provided on an outside of the exterior plate 3 relative to the sensor 10, an ultrasonic flaw detector 30 for controlling the sensor probe 20 and transmitting or recording a signal, a calculation device 40 for calculating a wall thickness or the like of the object 1 based on the signal recorded by the ultrasonic flaw detector 30, a display device 50 for displaying a measurement result calculated by the calculation device 40, a storage device 60 for storing the measurement result calculated by the calculation device 40, and an input device 70 for inputting an instruction to the calculation device 40.

The sensor 10 includes an ultrasonic transducer 11 and a sensor coil 12. The sensor probe 20 includes a transmission coil 21 and a reception coil 22. The ultrasonic flaw detector 30 includes a pulser 31, a receiver 32, and a data recorder 33. A drive signal is output to the transmission coil 21 from the pulser 31 based on a command from the calculation device 40. When the transmission coil 21 is driven, a current is generated in the sensor coil 12 by electromagnetic induction, and an ultrasonic wave is propagated into the object 1 from the ultrasonic transducer 11. The ultrasonic signal reflected by an inside of the object 1 is converted into a voltage signal by the sensor coil 12, and a current is generated again in the reception coil 22 by electromagnetic induction. The voltage signal generated in the reception coil 22 is output to the data recorder 33 via the receiver 32. The data recorder 33 is implemented by, for example, a hard disk or a memory. The calculation device 40 includes a ROM for storing a program and a CPU for executing processing according to the program.

Each of the sensor coil 12, the transmission coil 21, and the reception coil 22 has a structure in which a conductive wire is spirally wound in an x-y plane parallel to the surface of the object 1. The sensor coil 12, the transmission coil 21, and the reception coil 22 are provided facing the heat-preservation material 2 and the exterior plate 3, and the sensor coil 12, the heat-preservation material 2, the exterior plate 3, the transmission coil 21, and the reception coil 22 are provided in this order from a surface side of the object 1. At this time, in the present embodiment, the exterior plate opening 4 is provided in the exterior plate 3. For example, as shown in FIG. 1, the exterior plate opening 4 has a rectangular shape elongated in an x-axis direction, that is, a slit shape.

In FIG. 1, the number of turns of each of the sensor coil 12, the transmission coil 21, and the reception coil 22 is three, and the number of turns of three is shown in only an embodiment of the invention, and the number of turns of the coil is not limited thereto. The reception coil 22 is provided inside the transmission coil 21 in FIG. 1. Alternatively, the positions thereof are not limited thereto, and the transmission coil 21 may be provided inside the reception coil 22. The object 1, the sensor 10, the heat-preservation material 2, the exterior plate 3, and the sensor probe 20 are shown apart from each other for visibility of the illustrative drawing, and the object 1, the sensor 10, the heat-preservation material 2, the exterior plate 3, and the sensor probe 20 are actually provided close to each other in a z-axis direction in the drawing. The object 1 is assumed to be, for example, a pipe, and the object 1 is illustrated as a flat plate without a curved surface for ease of illustration.

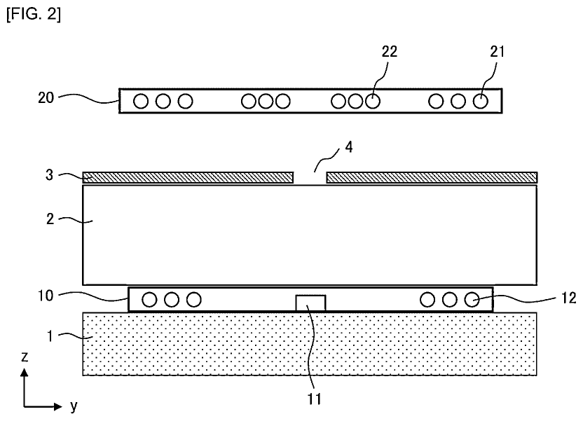

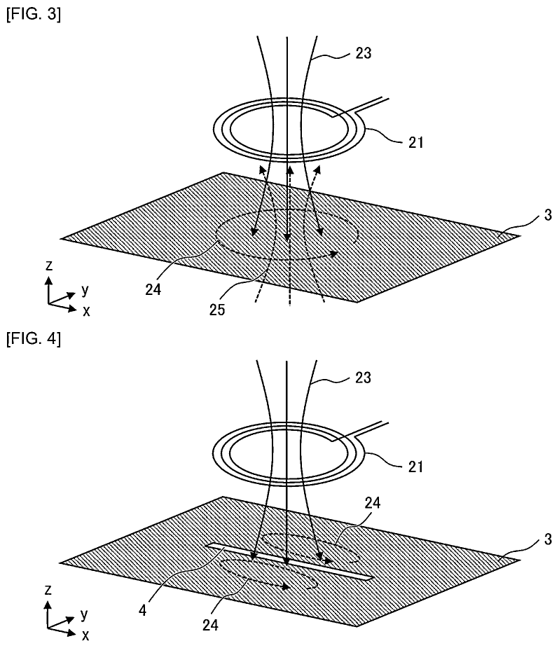

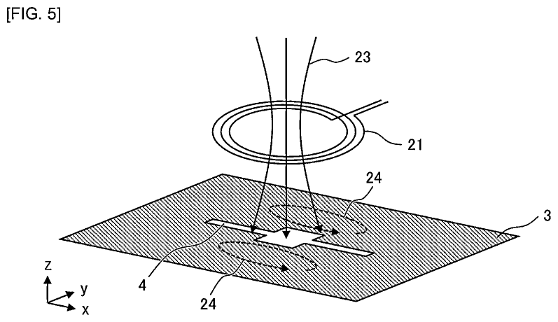

FIG. 2 is a diagram showing configurations and detailed arrangements of the sensor 10 and the sensor probe 20 as viewed from a side direction. In the transmission coil 21, a conductive wire is spirally wound in the x-y plane, and a magnetic field having a component perpendicular to the z-axis direction is generated. Due to the magnetic field perpendicular to the z-axis direction, a current is generated in the sensor coil 12 by electromagnetic induction. In the electromagnetic induction generated at this time, the magnetic field generated varies due to characteristics of the exterior plate opening 4. This will be described below with reference to FIGS. 3 and 4.

FIG. 3 is a diagram illustrating a magnetic field generated by electromagnetic induction when an exterior plate 3 without an opening is provided. When a current flows through the transmission coil 21, a coil magnetic flux 23 is generated. When the coil magnetic flux 23 penetrates a surface of the exterior plate 3, an eddy current 24 is generated coaxially with the transmission coil 21 on the surface of the exterior plate 3 because the exterior plate 3 is a metal member. An eddy current magnetic flux 25 is generated by the eddy current 24. The eddy current magnetic flux 25 is generated coaxially with the coil magnetic flux 23 in an opposing direction, and therefore, the magnetic fluxes in the z-axis direction shown in FIG. 3 cancel each other out. Therefore, the magnetic flux passing through the sensor coil 12 provided on a side opposite to the transmission coil 21 relative to the exterior plate 3 is reduced, and when the exterior plate 3 without an opening is provided, measurement by electromagnetic induction is difficult.

In the present embodiment, a metal member provided on the outside of the object is provided with a unit capable of performing measurement by electromagnetic induction. For example, the exterior plate opening 4 is provided in the exterior plate 3. Accordingly, it is possible to measure the wall thickness of a pipe from an outside of the metallic exterior plate 3 without impairing the retention of the heat-preservation material of the exterior plate 3 and without requiring removal of the exterior plate 3.

FIG. 4 is a diagram illustrating a magnetic field generated by electromagnetic induction when an exterior plate 3 including the exterior plate opening 4 is provided. When a current flows through the transmission coil 21, the coil magnetic flux 23 is generated. When the coil magnetic flux 23 penetrates the surface of the exterior plate 3, a transmission path of the current is blocked by the exterior plate opening 4, and therefore, eddy currents are not generated coaxially with the transmission coil 21, and are generated on both sides of the exterior plate opening 4. Therefore, the magnetic flux generated by the eddy current coaxially with the coil magnetic flux 23 in an opposing direction is not generated, and the magnetic fluxes of the coil magnetic flux 23 in the z-axis direction do not cancel each other out. Therefore, when a magnetic flux passing through the sensor coil 12 provided on the side opposite to the transmission coil 21 relative to the exterior plate 3 is generated and the exterior plate 3 including the exterior plate opening 4 is provided, measurement by electromagnetic induction can be performed. At this time, it is preferable that the following formula (1) is satisfied as a condition of the exterior plate opening 4 for preventing the transmission path of the current.

$$L 1 > D \qquad ( 1 )$$

Here, L1 represents a length of a long side of the exterior plate opening 4 as the slit, and D represents the outermost diameter of the transmission coil 21. That is, it is preferable that the length of the long side of the exterior plate opening 4 is larger than the outermost diameter of the transmission coil 21. According to the configuration described above, a signal can be transmitted/received to/from the ultrasonic transducer 11 from the outside of the exterior plate 3 without requiring removal of the exterior plate 3, and measurement of a wall thickness of a pipe or the like can be implemented.

When the shape of the exterior plate opening 4 does not satisfy the formula (1) and, for example, L1 is equal to or smaller than D, a current equal to the eddy current 24 as shown in FIG. 3 is generated outside the exterior plate opening 4 without interfering with the transmission path, and the eddy current magnetic flux 25 is generated coaxially with the coil magnetic flux 23 in an opposing direction, so that the magnetic fluxes in the z-axis direction cancel each other out.

In the present embodiment, the slit shape is shown as a basic requirement of the ultrasonic measurement method, and for example, the shape of the exterior plate opening 4 may be an ellipse or the like instead of a rectangle. In this case, a major axis of the ellipse is preferably larger than the outermost diameter of the coil. Further, the waveform and frequency of the ultrasonic wave transmitted from the pulse, the refraction angle at which the ultrasonic wave propagates, the display method of the search result, and the like are not limited. In addition, the device structures or techniques are not limited, and may be replaced with other structures or techniques by which the same effect can be obtained.

### Embodiment 2

Hereinafter, a second embodiment of the invention will be described with reference to FIG. 5.

An inspection device according to the present embodiment includes an exterior plate opening 4 different in shape from the exterior plate opening 4 shown in FIG. 1 of Embodiment 1. In Embodiment 1, the exterior plate opening 4 has a rectangular shape elongated in the x-axis direction. In Embodiment 2, for example, the exterior plate opening 4 having a shape obtained by combining a square with a long rectangular shape is provided. At this time, eddy currents 24 are generated on both sides of the exterior plate opening 4 by the coil magnetic flux 23, and the eddy current magnetic flux 25 is generated on an axis different from that of the coil magnetic flux 23 in an opposing direction. Due to the repulsion of the opposing magnetic flux, magnetic flux lines of the coil magnetic flux 23 are generated to avoid the surface of the exterior plate 3, and the density of the magnetic flux passing through an axis vertically downward is improved in the square portion of the exterior plate opening 4.

At this time, it is preferable that the following formula (2) is satisfied as a condition of the opening shape obtained by combining with the long rectangular shape.

$$D > W > L 2 \qquad ( 2 )$$

Here, L2 represents a length of a short side of the exterior plate opening 4, W represents a length of one side of the square portion, and D represents the outermost diameter of the transmission coil 21. That is, it is preferable that the length of one side of the square portion is larger than the length of the short side of the exterior plate opening 4. It is preferable that the outermost diameter of the transmission coil 21 is larger than the length of a side of the square portion.

According to the above operation, the magnetic flux passing through the sensor coil 12 provided on the side opposite to the transmission coil 21 relative to the exterior plate 3 can be made stronger, and the signal intensity can be increased.

When the length W of one side of the square portion does not satisfy the formula (2) and, for example, W is equal to or smaller than L2, the square portion of the exterior plate opening 4 is included in the rectangular shape, and thus the exterior plate opening 4 is the same as that in FIG. 4 of Embodiment 1. In addition, when W is equal to or larger than D, the exterior plate opening 4 is larger than the transmission coil 21 in the diameter, and therefore, the eddy current 24 is not generated. Accordingly, the opposing magnetic fluxes obtained by the operation of the present embodiment are hardly generated.

In the example shown in FIG. 5, the opening shape obtained by combining with the long rectangular shape is a square shape, and, for example, the opening shape may be different from the rectangular shape in directions of sides, and the shape may be a polygon other than a rectangle or a quadrilateral, a circle, an ellipse, or the like.

### REFERENCE SIGNS LIST

1: object
2: heat-preservation material
3: exterior plate
4: exterior plate opening
10: sensor
11: ultrasonic transducer
12: sensor coil
20: sensor probe
21: transmission coil
22: reception coil
23: coil magnetic flux
24: eddy current
25: eddy current magnetic flux
30: ultrasonic flaw detector
31: pulser
32: receiver
33: data recorder
40: calculation device
50: display device
60: storage device
70: input device

1. An ultrasonic inspection method implemented by:
an ultrasonic sensor attached to a surface of an object;
a sensor coil electrically connected to the ultrasonic sensor; and
a transmission and reception coil provided facing the sensor coil via a metal member provided on an outside of the object,
wherein the metal member provided on the outside of the object is provided with an opening.

2. The ultrasonic inspection method according to claim 1, wherein a full width in any one direction of the opening provided in the metal member is larger than a diameter of the transmission and reception coil, and a full width of the opening in a direction perpendicular to the one direction is smaller than the diameter of the transmission and reception coil.

3. The ultrasonic inspection method according to claim 1, wherein the opening provided in the metal member has a slit shape.

4. The ultrasonic inspection method according to claim 1, wherein a shape of the opening provided in the metal member is a superposition of a first opening shape and a second opening shape, a full width of the first opening shape in one direction being larger than a diameter of the transmission and reception coil, a full width of the first opening shape in a direction perpendicular to the one direction being smaller than the diameter of the transmission and reception coil, and a largest full width of the second opening shape being larger than a minimum width of the first opening shape and smaller than the diameter of the transmission and reception coil.

5. An ultrasonic inspection method implemented by:
an ultrasonic sensor attached to a surface of an object;
a sensor coil electrically connected to the ultrasonic sensor; and
a transmission and reception coil provided facing the sensor coil via a metal member provided on an outside of the object,
wherein the metal member provided on the outside of the object is provided with a unit that allows measurement by electromagnetic induction.
